(19) United States
(12) Patent Application Publication
(10) Pub. No.: US 2014/0193587 A1
(43) Pub. Date: Jul. 10, 2014

(54) METHODS OF TREATING WOOD WITH PRESERVATIVES USING SUPERCRITICAL NOBLE GASES

(71) Applicants: William B. Carlson, Seattle, WA (US); Gregory D. Phelan, Cortland, NY (US)

(72) Inventors: William B. Carlson, Seattle, WA (US); Gregory D. Phelan, Cortland, NY (US)

(73) Assignee: Empire Technology Development LLC

(21) Appl. No.: 13/878,103

(22) PCT Filed: Nov. 8, 2011
(86) PCT No.: PCT/US11/59803

§ 371 Date: Apr. 5, 2013

(51) Int. Cl. B27K 3/08; B27K 5/00

(52) U.S. Cl. CPC B27K 3/086; B27K 5/008
USPC 427/440

(57) ABSTRACT

Disclosed are methods and compositions pertaining to the preservation of wood using one or more noble gasses in conjunction with wood preservatives.

### TECHNICAL FIELD

This disclosure relates generally to methods and compositions pertaining to preserving wood.

### BACKGROUND

Wood is made of glucose, the main carbohydrate that fuels life. Plants can generate wood by polymerizing glucose sugar units (poly(1,4-β-glucose)) to create cellulose. Wood is used as the structural material in a wide variety of applications, such as houses, boats, buildings, and furniture. Being made of polymerized sugar, wood is a potential food source and can be consumed by living organisms that produce cellulase, an enzyme that cleaves the 1,4-β bonds that constitute cellulose. Therefore organisms that feed on cellulose, such as insects, bacteria, and fungi, can compromise the structural integrity of wood.

Solvents or liquids are often used to introduce preservatives into wood. Organic solvents such as methylene chloride or Freon (chlorofluorocarbons) have been used in the past to introduce the preservatives into wood, as they are largely non-flammable. However, while Freon is non-toxic, it depletes the ozone layer and is now a banned material. Methylene chloride has a host of toxicity and environmental issues. Thus, these solvents are being phased out of use with wood preservatives. Newer technologies use water dispersions under high pressure to introduce wood preservatives into the wood structure. This is the most common preservation method for pressure treated lumber. However, the water introduced into the wood along with the preservatives is very slow to evaporate. It is often necessary to completely dry the wood following high pressure introduction of the preservatives, as the dimensions of the wood product can change as the wood dries. Kilns are sometimes used to speed the drying process; however, this is very energy intensive and greatly increases carbon footprint.

Carbon dioxide has also been used as a solvent for introducing preservatives into wood. For example, U.S. Pat. No. 6,623,600 describes methods of impregnating wood with preservatives at high temperature and pressure using supercritical carbon dioxide as a solvent. However, carbon dioxide is a potent Lewis acid and can attack nucleophiles such as amines, hydroxyls, and thiols. These basic moieties are used in many wood preservatives and hydroxyls are found in cellulose, making these preservatives incompatible with carbon dioxide and rendering the cellulose itself susceptible to damage.

### SUMMARY

The compositions and methods described herein relate to methods of treating wood substrates with wood preservatives.

In one aspect, the present technology provides methods of treating wood substrate, including providing a wood substrate and contacting the wood substrate with a mixture having a supercritical liquid and at least one wood preservative. In some embodiments, the supercritical liquid includes a noble gas at a weight percent greater than 1.5%. In some embodiments, the contacting of the wood substrate occurs at a pressure sufficient to maintain the supercritical liquid in a supercritical liquid state.

In another aspect, the present technology provides a composition including, a supercritical liquid and at least one wood preservative, wherein the supercritical liquid includes at least one noble gas and the wood preservative includes a metal that is not an oxide or hydroxide.

In some embodiments of the compositions is under pressure. In some embodiments, the pressure is about 2,270 kPa to about 60,000 kPa. In some embodiments, the methods include contacting the wood substrate with a mixture of a supercritical liquid and at least one wood preservative at a pressure sufficient to maintain the supercritical liquid in a supercritical liquid state. In some embodiments, the pressure is about 6,000 kPa to about 15,000 kPa.

In some embodiments of the compositions and methods disclosed herein, the noble gas is neon, argon, krypton, xenon, or combinations thereof. In some embodiments, the noble gas is argon.

In some embodiments of the compositions and methods disclosed herein, the wood preservative is present in the mixture at about 0.1% to about 20% by weight. In some embodiments, the wood preservative is present in the mixture at about 1% to about 5% by weight.

In some embodiments of the methods disclosed herein, the wood preservative penetrates the surface of the wood substrate and is dispersed throughout the wood substrate.

In some embodiments of the compositions and methods disclosed herein, the wood preservative comprises a plurality of metal particles. In some embodiments, the metal particles are copper particles, zinc particles, or silver particles, or combinations thereof. In some embodiments, the metal particles have an average diameter of about 1 nm to about 1000 nm; an average diameter of about 20 nm to about 100 nm; or an average diameter of about 30 nm.

In some embodiments of the compositions and methods disclosed herein, the wood preservative includes a metal compound, an arsenic compound, or a boron compound soluble in liquid. In some embodiments, the metal compound is chromated copper arsenate, alkaline copper quaternary, copper azole, sodium borate, copper borate, zinc borate, copper carbonate, zinc carbonate, iron lignosulfate, or combinations thereof. In some embodiments, the wood preservative includes chitosan-copper complex, chitosan-zinc complex, copper dimethyldithiocarbamate, ethanolamine copper, or combinations thereof. In some embodiments, the wood preservative includes linseed oil, tung oil, sunflower oil, rapeseed oil, ukui oil, or combinations thereof. In some embodiments, the wood preservative includes an isothiazolinone compound. In some embodiments, the wood preservative includes paraben, naphthalene, tebuconazole, propiconazole, cypraconazole, silafluofen, decanal, iodopropynyl butylcarbamate (IPBC), 2-(thiocyanomethylthio)-benzothiazole (TCMTB), or combinations thereof.

The foregoing summary is illustrative only and is not intended to be in any way limiting. In addition to the illustrative aspects, embodiments, and features described above, further aspects, embodiments, and features will become apparent by reference to the following drawings and the detailed description.

### DETAILED DESCRIPTION

The illustrative embodiments described in the detailed description and claims are not meant to be limiting. Other embodiments may be utilized, and other changes may be made, without departing from the spirit or scope of the subject matter presented here.

Unless otherwise stated, the singular forms “a,” “an,” and “the” as used herein include plural reference.

“Noble gas” is defined herein as a class of elements that includes helium, neon, argon, krypton, xenon, and radon. The term “gas” in the phrase “noble gas” does not refer to the physical state of the element. For example, a noble gas can be in a gaseous state, a liquid state, or a supercritical liquid state.

“Supercritical liquid” is defined herein as a substance at a pressure and temperature above its critical point. The critical point is a pressure and temperature above which a substance has properties of a supercritical liquid. A substance above its critical point is in a supercritical liquid state. A supercritical liquid does not have a distinct liquid phase or gas phase but has physical properties of both. Supercritical fluids have greatly enhanced ability to solubilize compounds while being able to more easily penetrate substances like a gas. Typically, small changes in pressure of a supercritical fluid result in large changes in its density.

“Wood substrate” is defined herein as a substrate removed from a plant that contains a rigid cellulose structure in which the physical structure of the cellulose is substantially the same as that of the living plant. Plants can polymerize glucose sugar units (poly(1,4-β-glucose)) to create cellulose. Wood substrate includes, for example, wood, logs and lumber cut from frees, branches of trees and shrubs, as well as engineered wood products, such as particle board created from wood chips or particles, and plywood created from thin layers of wood bonded to gether. Wood cut from trees can include, for example: araucaria, cedar, cypress, douglas fir, european yew, balsam fir, silver fir, noble fir, pacific silver fir, hemlock, kauri, kaya, larch, pine, redcedar, redwood, rimu, spruce, sugi, white cedar, yellow cedar, alder, applewood, ash, aspen, balsa, basswood, beech, birch, cherry, cottonwood, dogwood, ebony, elm, eucalyptus, hickory, oak, poplar, walnut, and willow.

“Wood preservative” is defined herein as a chemical, compound, or particle that reduces or prevents damage to wood substrate. In certain embodiments, wood preservative reduces or prevents damage to wood substrate that is caused by fungus, insects, bacteria or the like.

“Particle” is defined herein as a small portion of a substance having a diameter less than or equal to 100 micrometers. A particle can have an irregular shape or a regular geometric shape, such as a sphere, cube, pyramid, a three dimensional polygon, or a two-dimensional polygon. A particle having a three dimensional polygon shape can have a hollow interior, or a lattice/cage-like structure such as that seen in carbon fullerenes (i.e. “buckyballs”). A particle may be made of metal, a polymer, or a crystalline compound, for example. Particles are not soluble in liquid and may form a colloidal suspension when mixed with a liquid.

As used herein, the term “about” in quantitative terms refers to plus or minus 10%. For example, “about 3%” would encompass 2.7-3.3% and “about 10%” would encompass 9-11%. Moreover, where “about” is used herein in conjunction with a quantitative term it is understood that in addition to the value plus or minus 10%, the exact value of the quantitative term is also contemplated and described. For example, the term “about 3%” expressly contemplates, describes and includes exactly 3%.

### Methods of Using Pressurized Gases to Deliver Wood Preservatives

Pressure-based processes are among the methods in use today for delivering preservatives into wood. Pressure processes have a number of advantages over the non-pressure methods. First, a deeper and more uniform penetration and a higher absorption of preservative are achieved. Second, the conditions under which the nano-scale preservatives are applied can be controlled so that retention and penetration can be varied. Third, pressure processes can be adapted to large-scale production. The pressure treatment method of impregnating wood is used to protect railroad ties, telephone poles, and building members, and structural materials currently used throughout the world.

Wood has hygroscopic characteristics and contains a relatively high amount of excess water after it has been harvested and cut, around 30% equilibrium moisture content (EMC) when saturated. The primary reason for drying wood to a moisture content equivalent to its mean EMC during use (“in service”) is to ensure that the wood structure does not expand or contract excessively while in service due to uptake or loss of moisture, and possibly harm the structural properties of the wood. The mean EMC for wood can vary between geographic regions, as well between interior uses and exterior uses within a given geographic location.

Water is often used as a carrying agent to aid in bringing the wood preservative evenly into the wood. However, this can leave the wood with excess water and require drying following treatment with wood preservatives. In addition, some compounds that might act as wood preservatives are unsuitable when used with a water carrier. For example, compounds that contain chlorine, bromine, or iodine substitutions are subject to nucleophilic attack when used with a water carrier. Ammonium compounds are also water sensitive. Amine compounds and triazin compounds can also be water sensitive under certain aqueous conditions such as low pH and can be attacked by Lewis acids and bases. Using supercritical noble gases as a carrier allows the water content to be adjusted before the wood is treated, thus allowing the wood to be immediately available, instead of requiring an additional drying step.

Chromated copper arsenate, ammoniacal copper zinc arsenate, ammoniacal copper citrate, alkaline copper quaternary compounds, copper azole, and copper dimethyldithocarbamate are all compounds that can be used with a water carrier. However, wood substrates treated with these compounds are also prone to leaching while the wood substrate is drying. Using supercritical noble gases as a carrier allows less of these compounds to be used as preservatives, since no water is used and thus leaching will not occur.

### Compositions of Noble Gases and Wood Preservatives

Disclosed herein are compositions that encompass at least one supercritical noble gas and at least one wood preservative. In some embodiments, the compositions include antimicrobial, antifungal and/or antibacterial properties, are contacted, surface-treated, or impregnated into wood at high pressure, and are useful as wood preservatives. Also disclosed herein are various wood stock (e.g., lumber, planks, siding etc.) and wood products (e.g., furniture, boats, decking, molding or other wood trim for indoor or outdoor use, siding, paneling, etc.) preserved with the compositions.

The noble gas can generally be present in the supercritical liquid at any weight percent. For example, the noble gas can be present at more than about 25 weight percent, more than about 50 weight percent, more than about 75 weight percent, more than about 90 weight percent, more than about 95 weight percent, or about 100 weight percent. Specific examples of the weight percent include about 25%; about 30%; about 35%; about 40%; about 45%; about 50%; about 55%; about 60%; about 65%; about 70%; about 75%; about 80%; about 85%; about 90%; about 95%; about 99%, 100%, or ranges between any two of these values.

The compositions can contain one or more noble gases. For example, the composition can contain one, two, three, four, fiver, or six noble gases. Specific examples of noble gases include helium, neon, argon, krypton, xenon, and radon.

The at least one wood preservative can generally be present in the composition at any concentration. For example, the wood preservative can be present at about 0.1% to about 20% by weight, or at about 1% to about 5% by weight. Specific examples of concentration by weight include about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 10%, about 15%, about 20%, and ranges between any two of these values.

A variety of wood preservatives may be used with supercritical noble gases and pressure processes to impregnate wood substrates. Such wood preservatives include, but are not limited to, metal-containing compounds, waxes, iazolin compounds, amine preservatives, oils, silicates, bifenthrin preservatives, and borate preservatives.

Metal-containing compounds can include, but are not limited to metal particles, such as nano-particles of copper, silver, or zinc. Metal-containing compounds can include metal salts and compounds, including, but not limited to, copper carbonate, zinc carbonate, copper borate, zinc borate, iron lignosulfate, copper lignosulfate, and zinc lignosulfate. Metal complexes can include chitosan-copper complex, chitosan-zinc complex, copper dimethyldithiocarbamate, and ethanolamine copper. In some embodiments, the metal-containing compound is not a metal oxide. In other embodiments, the metal-containing compound is not a metal hydroxide. In some embodiments, the metal particles are copper particles, zinc particles, or silver particles, or combinations thereof. In some embodiments, the metal particles have an average diameter of about 1 nm to about 1000 nm; an average diameter of about 20 nm to about 100 nm; or an average diameter of about 30 nm. Specific examples of average diameters include about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1000 nm, and ranges between any two of these values.

Iazolin compounds can also be used as wood preservatives. Iazolin compounds include, but are not limited to, 4,5-dichloro-2-N-octylisothiazolin-3-one, 4,5-dichloro-2-N-octylisothiazolin-3-one, 2-N-octyl-4-isothiazolin-3-one, 5-chloro-2-methyl-4-isothaliazolin-3-one, 1,2-benzisothiazolin-3-one, 2-n-octyl-4-isothiazolin-3-one, 2-methyl-2H-isothiazolin-3-one, 4-amino-6-(1,1-dimethylethyl)-3-(methyl-thio)-1,2,4-triazin-5 (4H)-one, 3-isopropyl-1H-2,1,3-benzothiadiazin 4 (3H)-one 2,2-dioxide, and 4-(mercaptomethyl)-2-methoxy-delta 2-1,3,4-thiadiazolin-5-one.

Amine compounds can be used as a preservative with supercritical noble gases at high pressure to impregnate and preserve wood substrates. Amine compounds include, but are not limited to, N′—N-(1,8-naphthalyl)hydroxylamine, 2,5-dimethylfuran-3-(3′-isopropyl)carboxyanilide, 1,3,5-tris(hydroxyethyl)triazine, 2-(4-thiazolyl)-1H-benzimidazole, aminopolycarboxylate, 3′-isopropyl(oxy)-5-methyl-2-trifluoromethylfuran-3-carboxylic acid anilide and amide wood preservative as shown by dialkylamides derived from mono-, di or tricarboxylic acids, 3-iodo-2-propynyl butylcarbamate.

Waxes are also compatible for use with supercritical noble gases and pressure processes to impregnate and preserve wood substrates. Typically, waxes do not exhibit antimicrobial activity, but do have some preservative effects on wood. Waxes that have been used as wood preservatives are montan wax, paraffin, bee's wax, candelilla wax, ouricury wax, sugarcane wax, retamo wax, Chinese wax, shellac wax, spermaceti, lanolin, bayberry wax, carnauba wax, castor wax, esparto wax, Japan wax, rice bean wax, soy wax, ceresin wax, peat, ozocerite, amide waxes, and jojoba oil.

Oils can be used as wood preservatives with supercritical noble gases and pressure processes to impregnate wood substrates. Exemplary oils include, but are not limited to linseed oil, tung oil, sunflower oil, rapeseed oil, kukui oil, pentachlorophenol, tar, coal tar creosote, and creosote.

Silicates are also useful as wood preservatives, and include sodium silicate and potassium silicate. Silicates can also be mixed with boron compounds, cellulose, lignin, and other plant extracts.

Borate compounds have also been used as preservatives. Borate compounds can include boronic acids such as phenyl boronic acid, N-methylamino-4-methylcatechol borate, N-methylamino-2,3-naphthyl borate, and N-methylaminocatechol borate. Bifenthrin and borate compounds are sometimes mixed together.

In some embodiments, the composition is under pressure. In some embodiments, the pressure is about 2,270 kPa to about 60,000 kPa. In some embodiments, the pressure is about 6,000 kPa to about 15,000 kPa. Specific examples of pressure include about 2,000 kPa, about 3,000 kPa, about 4,000 kPa, about 5,000 kPa, about 6,000 kPa, about 7,000 kPa, about 8,000 kPa, about 9,000 kPa, about 10,000 kPa, about 11,000 kPa, about 12,000 kPa, about 13,000 kPa, about 14,000 kPa, about 15,000 kPa, about 20,000 kPa, about 30,000 kPa, about 40,000 kPa, about 50,000 kPa, about 60,000 kPa, and ranges between any two of these values.

The various compositions can be prepared by contacting the at least one wood preservative and the supercritical liquid to form the composition. The preparation method can include mixing, stirring, agitating, blending, or otherwise physically combining the wood preservative and the supercritical liquid. The composition can be prepared immediately before use, or can be prepared in advance and stored prior to use.

### Methods of Using Noble Gas at High Pressure to Deliver Wood Preservatives

Disclosed herein are methods of delivering wood preservatives into wood using supercritical noble gases. In some embodiments, the methods include impregnating a wood with a composition comprising at least one noble gas and at least one wood preservative. In some embodiments, the compositions are impregnated into wood at high pressure. Also disclosed herein are various wood stock (e.g., lumber, planks, siding etc.) and wood products (e.g., furniture, boats, decking, molding or other wood trim for indoor or outdoor use, siding, paneling, etc.) preserved using the methods and compositions disclosed herein.

The noble gases are a series of gases that have their outer valence shell completely filled and as such are highly inert to chemical reactions. Only a handful of chemical compounds of these gases are known. The noble gases do not support combustion and are non-toxic. Argon constitutes 1.28% of earth's atmosphere and as such is very plentiful. In addition, it is inexpensive to isolate. The abundance of krypton in the atmosphere is thought to be about 0.000108-0.000114%, making it the seventh most common gas in the atmosphere. Xenon is a trace gas in Earth's atmosphere.

The noble gases require relatively low critical pressures and critical temperatures to bring the gases into a supercritical state. The critical pressures and critical temperatures are easily obtainable by modern compression technology. Table 1 below lists the critical pressure and temperature for each of the noble gases.

TABLE 1
Critical Pressure and Temperature of the Noble Gases

| Gas | Critical Pressure (kPa) | Critical Temperature (° C.) |
|---|---|---|
| Helium | 2,270 | −267.96 |
| Neon | 2,760 | −228.75 |
| Argon | 4,870 | −122.4 |
| Krypton | 5,500 | −63.8 |
| Xenon | 5,840 | +16.6 |
| Radon | 6,280 | +103.85 |

Carbon dioxide also has a relatively low critical pressure (7599 kPa) and critical temperature (31° C.) that is comparable to that of the noble gases. However, carbon dioxide itself is a nonpolar molecule as the center of positive charge and the center of negative charge lie atop each other. The two electronegative oxygen atoms impart a very strong positive charge on the carbon leading to acidic properties. Any basic moiety such as hydroxyls or amines is highly susceptible to attack from carbon dioxide to form carbamates or carbonates. Thus, use of carbon dioxide as a solvent for wood preservatives is limited due to its acidic properties.

In some embodiments, the methods can include providing a wood substrate, and contacting the wood substrate with a mixture comprising a supercritical liquid and at least one wood preservative. The mixture can generally be any of the compositions described above. For example, the supercritical liquid can comprise at least one noble gas at a weight percent greater than 1.5%.

The contacting can be performed at generally any pressure and temperature sufficient to maintain the supercritical liquid in a supercritical liquid state. The pressure and temperature may vary depending on the one or more noble gases selected.

In some embodiments, the mixture is under pressure while it is used to treat wood. In some embodiments, the pressure is about 2,270 kPa to about 60,000 kPa. In some embodiments, the pressure is about 6,000 kPa to about 15,000 kPa. Specific examples of pressure include about 2,000 kPa, about 3,000 kPa, about 4,000 kPa, about 5,000 kPa, about 6,000 kPa, about 7,000 kPa, about 8,000 kPa, about 9,000 kPa, about 10,000 kPa, about 11,000 kPa, about 12,000 kPa, about 13,000 kPa, about 14,000 kPa, about 15,000 kPa, about 20,000 kPa, about 30,000 kPa, about 40,000 kPa, about 50,000 kPa, about 60,000 kPa, and ranges between any two of these values.

The contacting step can generally be performed for any length of time suitable for treating the wood substrate. The length of time may vary according to the thickness, density, porosity, and condition of the wood substrate. Examples of time include 20 minutes for softer woods such as pine and hemlock, and 1 hour for harder woods, such as cherry.

The method can further comprise removing the supercritical liquid after the contacting step. The removing may be a physical removing such as pumping, pouring, decanting, draining, and so on the supercritical liquid away from the wood substrate. Alternatively or additionally, the removing can include changing the temperature, pressure, or both temperature and pressure of the supercritical fluid. The changing can include lowering the pressure, lowering the temperature, or both lowering the pressure and lowering the temperature. The removing can include allowing the supercritical liquid to change from a liquid state into a gaseous state.

### EXAMPLES

The present compositions and methods thus generally described, will be understood more readily by reference to the following examples, which are provided by way of illustration and are not intended to be limiting. The following is a description of the materials and experimental procedures used in the Examples.

### Example 1

### Using Supercritical Argon at 30.397 kPa to Introduce Nanoparticles into Wood

To introduce nanoparticles into wood, 30 nanometer (nm) copper nanoparticles are placed into a high pressure vessel. Argon is introduced into the vessel and the pressure and temperature in the vessel are increased to bring the argon to a supercritical state, about 30,397 kPa (about 300 atmospheres) and about 80° C. A dispersion containing 5 weight % copper nanoparticles is created by mixing and agitating the nanoparticles with the supercritical argon.

The wood substrate to be treated is placed in a second high pressure vessel, and raised to a similar pressure and temperature as that created in the first high pressure vessel containing the supercritical argon dispersion. The supercritical argon dispersion is introduced into the vessel containing the wood and allowed to penetrate the wood for about 20 minutes. The pressure in the closed vessel is regulated at a high enough level, about 30,397 kPa, to ensure that the dispersion sufficiently penetrates the wood at the molecular level. The high pressure and the temperature (about 80° C.) maintained in the closed vessel also ensures that the argon is kept in a supercritical state.

Once the preservatives are impregnated into the wood structure using supercritical argon, the pressure is slowly released at a constant rate of between about 10-50 kPa/minute, allowing the argon to revert back to the gaseous state. As the pressure is decreased in the vessel, the gaseous argon diffuses from the wood substrate, leaving behind the copper nanoparticles.

The treated wood will display improved properties relative to an untreated wood control. For example, treated wood substrate will have less warping, less degradation, improved strength, and immediate useability. Treated wood substrate will also retain its color and the preservatives will be less prone to leaching out of the wood substrate.

While the present example uses copper nanoparticles as a preservative, it is understood that other metal-containing compounds, waxes, iazolin compounds, amine preservatives, oils, silicates, bifenthrin preservatives, and/or borate could also be used as a preservative.

### Example 2

### Using Supercritical Argon at 20,000 kPa to Introduce Nanoparticles into Wood

To introduce nanoparticles into wood, 50 nm zinc nanoparticles are placed into a high pressure vessel. Argon is introduced into the vessel and the pressure and temperature in the vessel are increased to bring the argon to a supercritical state, about 20,000 kPa (about 200 atmospheres) and about 30° C. A dispersion containing 5 weight % copper nanoparticles is created by mixing and agitating the nanoparticles with the supercritical argon.

The wood substrate to be treated is placed in a second high pressure vessel, and raised to a similar pressure and temperature as that created in the first high pressure vessel containing the supercritical argon dispersion. The rate of pressure increase in the second vessel is rapid, about 1500 kPa/minute. The supercritical argon dispersion is introduced into the vessel containing the wood and allowed to penetrate the wood for about 20 minutes. Once the preservatives are impregnated into the wood structure using supercritical argon, the pressure is slowly released at a constant rate of between about 10-50 kPa/minute, allowing the argon to revert back to the gaseous state. As the pressure is decreased in the vessel, the gaseous argon diffuses from the wood substrate, leaving behind the copper nanoparticles in the pores of the wood substrate.

The treated wood will display improved properties relative to an untreated wood control. For example, treated wood substrate will have less warping, less degradation, improved strength, and immediate useability. Treated wood substrate will also retain its color and the preservatives will be less prone to leaching out of the wood substrate.

While the present example uses copper nanoparticles as a preservative, it is understood that other metal-containing compounds, waxes, iazolin compounds, amine preservatives, oils, silicates, bifenthrin preservatives, and/or borate could also be used as a preservative.

### Example 3

### Stepped Pressure Reduction for Wood Exposed to Argon and Nanoparticles at High Pressure

Silver nanoparticles (100 nm in diameter) are introduced to wood by dispersing the nanoparticles in supercritical argon, at a temperature and pressure as described in Example 2 (30° C. and about 20,000 kPa). Once the nanoparticles have been embedded in the wood substrate, the pressure is lowered until it is just above the supercritical point for argon. Then a pulsing pressure sequence is used, in which the pressure is decreased by 2000 kPa and then increased by 1000 kPa, yielding a net decrease of 1000 kPa. The decrease in pressure occurs at a rate of about 100 kPa/minute. The pulsating pressure continues until the second vessel reaches about 2000 kPa. From 2000 kPa to atmospheric pressure, the pressure decrease is no longer pulsed and decreases at a rate of about 50 kPa/minute.

The treated wood will display improved properties relative to an untreated wood control. For example, treated wood substrate will have less warping, less degradation, improved strength, and immediate useability. Treated wood substrate will also retain its color and the preservatives will be less prone to leaching out of the wood substrate.

While the present example uses copper nanoparticles as a preservative, it is understood that other metal-containing compounds, waxes, iazolin compounds, amine preservatives, oils, silicates, bifenthrin preservatives, and/or borate could also be used as a preservative.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken, down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 particles refers to groups having 1, 2, or 3 particles. Similarly, a group having 1-5 particles refers to groups having 1, 2, 3, 4, or 5 particles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of treating a wood substrate, the method comprising:
providing a wood substrate; and
contacting the wood substrate with a mixture comprising a supercritical liquid and at least one wood preservative, wherein the supercritical liquid comprises at least one noble gas at a weight percent greater than 1.5%, and wherein the contacting occurs at a pressure sufficient to maintain the supercritical liquid in a supercritical liquid state.

2. The method of claim 1, wherein the noble gas is present in the supercritical liquid at a weight percent of more than about 25%.

3. The method of claim 2, wherein the noble gas is present in the supercritical liquid at a weight percent of more than about 50%.

4. The method of claim 3, wherein the noble gas is present in the supercritical liquid at a weight percent of more than about 75%.

5. The method of claim 4, wherein the noble gas is present in the supercritical liquid at a weight percent of more than about 99%.

6. The method of any one of claims 1-5, wherein the pressure is about 2,270 kPa to about 60,000 kPa.

7. The method of claim 6, wherein the pressure is about 6,000 kPa to about 15,000 kPa.

8. The method of any one of claims 1-7, wherein the noble gas is neon, argon, krypton, xenon, or combinations thereof.

9. The method of claim 8, wherein the noble gas is argon.

10. The method of any one of claims 1-9, wherein the wood preservative is present in the mixture at about 0.1% to about 20% by weight.

11. The method of claim 10, wherein the wood preservative is present in the mixture at about 1% to about 5% by weight.

12. The method of any one of claims 1-11, wherein the wood preservative penetrates the surface of the wood substrate and is dispersed throughout the wood substrate.

13. The method of any one of claims 1-12, wherein the wood preservative comprises a plurality of metal particles.

14. The method of claim 13, wherein the metal particles are copper particles, zinc particles, or silver particles, or combinations thereof.

15. The method of claim 14, wherein the metal particles have an average diameter of about 1 nm to about 1000 nm.

16. The method of claim 14, wherein the metal particles have an average diameter of about 20 nm to about 100 nm.

17. The method of claim 16, wherein the metal particles have an average diameter of about 30 nm.

18. The method of any one of claims 1-12, wherein the wood preservative comprises a metal compound, an arsenic compound, or a boron compound soluble in liquid.

19. The method of claim 18, wherein the metal compound is chromated copper arsenate, alkaline copper quaternary, copper azole, sodium borate, copper borate, zinc borate, copper carbonate, zinc carbonate, iron lignosulfate, or combinations thereof.

20. The method of any one of claims 1-12, wherein the wood preservative comprises chitosan-copper complex, chitosan-zinc complex, copper dimethyldithiocarbamate, ethanolamine copper, or combinations thereof.

21. The method of any one of claims 1-12, wherein the wood preservative comprises linseed oil, tung oil, sunflower oil, rapeseed oil, kukui oil, or combinations thereof.

22. The method of claim any one of claims 1-12, wherein the wood preservative comprises an isothiazolinone compound.

23. The method of claim any one of claims 1-12, wherein the wood preservative comprises paraben, naphthalene, tebuconazole, propiconazole, cypraconazole, silafluofen, decanal, iodopropynyl butylcarbamate (IPBC), 2-(thiocyanomethylthio)-benzothiazole (TCMTB), or combinations thereof.

24. A composition comprising a supercritical liquid and at least one wood preservative, wherein the supercritical liquid comprises at least one noble gas and the wood preservative comprises a metal that is not an oxide or hydroxide.

25. The composition of claim 24, wherein the noble gas is present in the supercritical liquid at a weight percent of more than about 25%.

26. The composition of claim 24, wherein the noble gas is present in the supercritical liquid at a weight percent of more than about 50%.

27. The composition of claim 24, wherein the noble gas is present in the supercritical liquid at a weight percent of more than about 75%.

28. The composition of claim 24, wherein the noble gas is present in the supercritical liquid at a weight percent of more than about 99%.

29. The composition of any one of claims 24-28, wherein the composition is at a pressure of about 2,270 kPa to about 60,000 kPa.

30. The composition of claim 29, wherein the pressure is about 6,000 kPa to about 15,000 kPa.

31. The composition of any one of claims 24-30, wherein the noble gas is neon, argon, krypton, xenon, or combinations thereof.

32. The composition of claim 31, wherein the noble gas is argon.

33. The composition of any one of claims 24-32, wherein the wood preservative is present in the mixture at about 0.1% to about 20% by weight.

34. The composition of claim 33, wherein the wood preservative is present in the mixture at about 1% to about 5% by weight.

35. The composition of any one of claims 24-34, wherein the wood preservative comprises a plurality of metal particles.

36. The composition of claim 35, wherein the metal particles comprise copper, zinc, silver, or combinations thereof.

37. The composition of any one of claims 35-36, wherein the metal particle has an average diameter of about 1 nm to about 1000 nm.

38. The composition of claim 37, wherein the metal particle has an average diameter of about 20 nm to about 100 nm.

39. The composition of claim 38, wherein the metal particle has an average diameter of about 30 nm.

40. The composition of any one of claims 24-34, wherein the wood preservative comprises a metal compound, an arsenic compound, or a boron compound soluble in liquid.

41. The composition of claim 40, wherein the metal compound is chromated copper arsenate, alkaline copper quaternary, copper azole, sodium borate, copper borate, zinc borate, copper carbonate, zinc carbonate, iron lignosulfate, or combinations thereof.

42. The composition of any one of claims 24-34, wherein the wood preservative comprises a chitosan-copper complex, a chitosan-zinc complex, copper dimethyldithiocarbamate, ethanolamine copper, or combinations thereof.

43. The composition of any one of claims 24-34, wherein the wood preservative comprises linseed oil, tung oil, sunflower oil, rapeseed oil, kukui oil, or combinations thereof.

44. The composition of claim any one of claims 24-34, wherein the wood preservative comprises an isothiazolinone compound.

45. The composition of any one of claims 24-34, wherein the wood preservative comprises paraben, naphthalene, tebuconazole, propiconazole, cypraconazole, silafluofen, decanal, iodopropynyl butylcarbamate (IPBC), 2-(thiocyanomethylthio)-benzothiazole (TCMTB), or combinations thereof.
